(19) United States
(12) Patent Application Publication
(10) Pub. No.: US 2016/0201465 A1
(43) Pub. Date: Jul. 14, 2016

(54) TURBINE ROTOR MATERIAL FOR GEOTHERMAL POWER GENERATION AND METHOD FOR PRODUCING THE SAME

(71) Applicant: JAPAN CASTING & FORGING CORPORATION, Fukuoka (JP)

(72) Inventors: Yoshinori Yahiro, Kitakyushu-shi (JP); Yasushi Wakeshima, Kitakyushu-shi (JP)

(73) Assignee: JAPAN CASTING & FORGING CORPORATION, Kitakyushu-shi, Fukuoka (JP)

(21) Appl. No.: 14/907,919

(22) PCT Filed: Apr. 16, 2015
(86) PCT No.: PCT/JP2015/061702

§ 371 Date: Jan. 27, 2016

(30) Foreign Application Priority Data
Apr. 23, 2014 (JP) 2014-089219

(51) Int. Cl. F01D 5/02; C22C 38/44; C22C 38/04; C21D 1/84; C21D 9/00; C21D 8/00; C21D 6/00; C22C 38/46; C22C 38/02

(52) U.S. Cl. CPC F01D 5/02; C22C 38/46; C22C 38/44; C22C 38/04; C22C 38/02; C21D 9/0068; C21D 8/005; C21D 6/004; C21D 6/005; C21D 6/008; C21D 1/84; F05D 2220/30; F05D 2230/40; F05D 2230/25; F05D 2300/171

(57) ABSTRACT

A turbine rotor material for geothermal power generation containing C: 0.20 to 0.30 mass %, Si: 0.01 to 0.2 mass %, Mn: 0.5 to 1.5 mass %, Cr: 2.0 to 3.5 mass %, V: more than 0.15 mass % and 0.35 mass % or less, predetermined amounts of Ni and Mo, and a remainder consisting of Fe and inevitable impurities, the Ni made to be more than 0 and 0.25 mass % or less, the Mo made to be 1.05 to 1.5 mass %. Even a body diameter of 1600 mm or more can thereby be quenched, enabling provision of a turbine rotor material for geothermal power generation less prone to stress corrosion cracking even in a hydrogen sulfide environment and a method for producing the same.

### TECHNICAL FIELD

The present invention relates to a turbine rotor material to be used in a corrosive environment such as a hydrogen sulfide environment, and relates especially to a large-diameter turbine rotor material for geothermal power generation of 1600 mm or more and a method for producing the same.

### BACKGROUND ART

As a turbine rotor material for geothermal power generation, as described in Patent Literatures 1 to 4, a low-alloy steel containing Cr and Mo (generally called “1Cr-1Mo steel”) is used. Up to a diameter of 1500 mm, this 1Cr-1Mo steel can be quenched adequately and also has a necessary level of toughness.

However, in association with an increase in sizes of recent devices, there has been a demand for a turbine rotor material for geothermal power generation of 1600 mm or more in diameter. When the conventional 1Cr-1Mo steel is used, due to the large diameter, a cooling rate sharply decreases, and in association with precipitation of ferrite, toughness decreases.

On the other hand, for a turbine rotor material for thermal power generation, as described in Patent Literatures 5 and 6, a steel commonly known as 2.25 Cr-1 Mo steel in which an amount of Cr is increased is used. When this turbine rotor material is used, even a turbine rotor material having a diameter of 1900 mm can be adequately quenched to the inside.

### CITATION LIST

### Patent Literature

### Patent Literature 1: Japanese Unexamined Patent Application Publication No. 62-290849

### Patent Literature 2: Japanese Unexamined Patent Application Publication No. 63-035759

### Patent Literature 3: Japanese Unexamined Patent Application Publication No. 60-005853

### Patent Literature 4: Japanese Unexamined Patent Application Publication No. 52-030716

### Patent Literature 5: Japanese Unexamined Patent Application Publication No. 2001-221003

### Patent Literature 6: Japanese Unexamined Patent Application Publication No. 2002-339036

### SUMMARY OF INVENTION

### Technical Problem

However, in the case of the turbine rotor material for geothermal power generation, a maximum service temperature is approximately 250° C., and high-temperature creep strength required for the turbine rotor material for thermal power generation is not a requirement. On the other hand, since the turbine rotor material for geothermal power generation is used in hydrogen sulfide environments, stress corrosion cracking (SCC) becomes a problem.

SCC resistance of the 1Cr-1Mo steel which is a conventional steel for the above turbine rotor material for geothermal power generation and the 2.25Cr-1 Mo steel which is a conventional steel for the above turbine rotor material for thermal power generation were evaluated based on a test method of NACE (National Association of Corrosion Engineers) standard TM0177-Method B and by 3-point bend test in a saturated H2S solution to which acetic acid of 0.5 mass % was added. In the test, test specimens of 67.3×4.57×1.52 mm were used, stress was loaded in a range from 0.33 σ to 0.70 σ, the 1Cr-1Mo steel and the 2.25Cr-1 Mo steel were soaked in the saturated H2S solution for 720 hours, and existence of ruptures was evaluated. Table 1 shows results of the test using a test specimen of 1Cr-1Mo steel and a test specimen of 2.25Cr-1 Mo steel.

TABLE 1

| Load Stress | | |
|---|---|---|
| (MPa) | 1Cr—1Mo Steel | 2.25Cr—1Mo Steel |
| 0.70 σ | Y | Y |
| 0.67 σ | Y | Y |
| 0.63 σ | Y | Y |
| 0.60 σ | Y | Y |
| 0.56 σ | N | Y |
| 0.53 σ | N | Y |
| 0.50 σ | N | N |
| 0.47 σ | N | N |
| 0.45 σ | N | N |
| 0.42 σ | N | N |
| 0.40 σ | N | N |
| 0.37 σ | N | N |
| 0.33 σ | N | N |

Here, σ is a 0.2% yield strength of samples. In the table, N indicates no rupture, and Y indicates the existence of ruptures. It turns out that the 2.25Cr-1 Mo steel is, as compared with the 1Cr-1Mo steel, inferior in the SCC resistance. That is to say, the 2.25Cr-1Mo steel ensures hardenability in a central portion even when a body diameter is 1600 mm or more, however, the 2.25Cr-1Mo steel is inferior to 1Cr-1Mo steel in the SCC resistance.

The present invention has been made in view of the above circumstances, and an object thereof is to provide a turbine rotor material for geothermal power generation of which hardenability can be ensured even when a diameter of a body is 1600 mm or more and that is less prone to stress corrosion cracking even in a hydrogen sulfide environment and a method for producing the turbine rotor material for geothermal power generation.

### Solution to Problem

In order to achieve the above object, a turbine rotor material for geothermal power generation according to a first aspect of the present invention includes C: 0.20 to 0.30 mass %, Si: 0.01 to 0.2 mass %, Mn: 0.5 to 1.5 mass %, Cr: 2.0 to 3.5 mass %, V: more than 0.15 mass % and 0.35 mass % or less, predetermined amounts of Ni and Mo, and a remainder consisting of Fe and inevitable impurities, the Ni made to be more than 0 and 0.25 mass % or less, the Mo made to be 1.05 to 1.5 mass %.

In the case of the turbine rotor material for geothermal power generation according to the first aspect of the present invention, it is preferred that there be no ferrite in a matrix structure and the matrix structure be a bainitic homogeneous microstructure. Necessary strength and toughness can thereby be ensured.

In the case of the turbine rotor material for geothermal power generation according to the first aspect of the present invention, it is preferred that the turbine rotor material for geothermal power generation be provided with a body having a diameter of at least 1600 mm, room-temperature 0.2% yield strength of 685 MPa or more, room-temperature Charpy impact absorption energy of 20 J or more, and ductility-brittleness transition temperature of 80° C. or lower. Since a turbine rotor material for geothermal power generation needs to form a bainitic homogeneous microstructure, it is desirable for an upper limit for a diameter to be 2200 mm (more preferably, 2000 mm).

Descriptions will be given on an alloy composition of the turbine rotor material for geothermal power generation according to the first aspect of the present invention.

C: 0.20 to 0.30 mass %
C has an effect to enhance hardenability at the time of heat treatment, as well as an effect to form carbides with carbide-forming elements to enhance material strength. In order to obtain sufficient material strength, an addition of at least 0.20 mass % is necessary. On the other hand, when the amount of C exceeds 0.30 mass %, the ductility-brittleness transition temperature rises, decreasing toughness.

Si: 0.01 to 0.2 mass %

Si is added as a deoxidizing agent, and when an amount of Si is less than 0.01 mass %, the effect of Si is not sufficient. On the other hand, when Si is added in plenty, SiO₂, a product from deoxidization, remains in molten steel, which lowers cleanliness of and decreases toughness of steel. Therefore, the Si content is limited to a range from 0.01 to 0.2 mass %.

Mn: 0.5 to 1.5 mass %

Mn is also efficacious as a deoxidizing agent for molten steel. Mn is also efficacious for enhancing hardenability and controlling ferrite precipitation at the time of cooling of quenching. Due to this, an addition of at least 0.5 mass % is necessary. On the other hand, Mn of more than 1.5 mass % has an effect to advance temper embrittlement, which decreases toughness. Thus, the Mn content is set in a range from 0.5 to 1.5 mass %.

Ni: more than 0 and 0.25 mass % or less

Ni is an element efficacious for controlling ferrite precipitation at the time of cooling of quenching. However, it is generally known that excess content of Ni tends to incur sulfide stress corrosion cracking. Due to this, as a result of various studies on susceptibility to sulfide stress corrosion cracking as a turbine rotor material for geothermal power generation, the inventors found out that the susceptibility to sulfide stress corrosion cracking can be lowered by decreasing the Ni content as much as possible and keeping the Ni content within a range of 0.25 mass % or less. Even when the amount of Ni is decreased, by containing Cr of 2.0 mass % or more and Mo of 1.05 mass % or more, precipitation of ferrite can be prevented and a bainitic homogeneous microstructure can be obtained.

Cr: 2.0 to 3.5 mass %

Cr is an element efficacious for improving hardenability and controlling ferrite precipitation at the time of cooling of quenching. Cr is also efficacious for forming carbides to enhance material strength, as well as enhancing corrosion resistance. In order to obtain adequate hardenability, material strength, and corrosion resistance, an addition of at least 2.0 mass % is necessary. On the other hand, Cr of more than 3.5 mass % decreases toughness. Therefore, the Cr content is set in a range from 2.0 to 3.5 mass %.

Mo: 1.05 to 1.5 mass %

Mo is, as with Cr, efficacious for improving hardenability, and also efficacious for improving temper embrittlement and forming carbides to enhance material strength. Due to this, an addition of at least 1.05 mass % is necessary, however, an excess addition saturates these effects and decreases toughness. Therefore, the Mo content is set in a range from 1.05 to 1.5 mass %.

V: more than 0.15 mass % and 0.35 mass % or less

V is an element efficacious for making a large amount of precipitated fine carbides in grains with C to enhance material strength. In order to obtain the above effect, V of more than 0.15 mass % is necessary. On the other hand, V of more than 0.35 mass % decreases toughness. Therefore, the V content is set in a range from more than 0.15 mass % to 0.35 mass % or less.

Next, descriptions will be given on a mechanical property as a turbine rotor material for geothermal power generation.

As a goal, a room-temperature 0.2% yield strength in a central portion of a turbine rotor material for geothermal power generation after thermal refining is set to be 685 MPa or more.

In geothermal power generation, it is necessary for a steam temperature to be 250° C. or lower and for a ductility-brittleness (fracture surface) transition temperature to be sufficiently low. As a goal, the ductility-brittleness transition temperature is set to be 80° C. or lower, and the room-temperature Charpy impact absorption energy is set to be 20 J or more.

Also, a method for producing a turbine rotor material for geothermal power generation according to a second aspect of the present invention is a suitable producing method for obtaining a targeted mechanical property by controlling ferrite precipitation at the time of cooling of quenching of a steel ingot having the constituents of the turbine rotor material for geothermal power generation according to the first aspect of the present invention to achieve a bainitic homogeneous microstructure. Descriptions will be given hereunder on a method for producing this turbine rotor material for geothermal power generation (low-alloy steel).

In the case of a manufacturing method for this low-alloy steel, first, a steel ingot in a shape suitable for free forging and the like is produced from molten steel which is an alloy raw material to be a forged steel member smelted so as to have a targeted component composition after having gone through a melting furnace such as an electric furnace and a vacuum induction melting furnace, and even vacuum carbon deoxidization method or electroslag remelting process and the like. With respect to the steel ingot after solidification, an air gap on the inside of the steel ingot is pressure-bonded by high-temperature heat and severe forging pressure (hot forging), a coarsened steel structure becomes ameliorated, and the steel ingot is molded to form a forged steel member. Next, this member is subjected to quenching treatment that heats this member to 900 to 950° C., and cools down this member from 800° C. down to 500° C. at a cooling rate of 1.0° C./minute or faster, and subsequently subjected to tempering treatment that re-heats this member to retain a temperature of 610 to 690° C. and then cools down this member.

With regard to the quenching treatment, unless the forged steel member is heated to a temperature of 900° C. or higher, solid solution of carbides does not progress, which lowers hardenability, decreasing the toughness due to ferrite precipitation at the time of cooling. On the other hand, heating the forged steel member to a temperature exceeding 950° C. coarsens grain size and decreases the toughness. Therefore, it is desirable for the quenching temperature to be 900 to 950° C. Also, in the case of a large forged steel member, since time taken to become uniformly heated differs between a surface part and a central part, duration of heating can be set depending on a size of a forged steel member. In the case of cooling at the time of quenching, by making a cooling rate fast, precipitation of ferrite can be controlled, and toughness can be enhanced. However, in a large forged steel member, the cooling rate decreases drastically in a central part. This low-alloy steel has constituents on the assumption of a central part of a large forged steel member, which does not incur precipitation of ferrite or decrease toughness if the cooling rate while cooling from 800° C. down to 500° C. is 1.0° C./minute or faster. As long as this cooling condition is satisfied, any cooling method can be employed.

With regard to the tempering treatment, effects of the tempering treatment do not become exerted enough at a low temperature lower than 610° C., failing to achieve a targeted toughness, and an excess temperature exceeding 690° C. coarsens carbides, failing to obtain a targeted material strength. Therefore, it is desirable for the tempering temperature to be 610 to 690° C. Also, since the time taken to become uniformly heated differs between a surface part and a central part in a large forged steel member, duration of heating can be set depending on a size of a forged steel member.

### Advantageous Effects of Invention

In the case of the turbine rotor material for geothermal power generation and a method for producing the turbine rotor material for geothermal power generation according to the present invention, in the low-alloy steel containing Cr of 2.0 to 3.5 mass %, since the amount of Ni is made to be 0.25 mass % or less and the amount of Mo is made to be 1.05 to 1.5 mass %, even when a diameter of a body of a turbine rotor material is 1600 mm or more (or even 1900 mm or more), generation of ferrite is prevented and an inside of the body becomes quenched, and SCC resistance becomes strong even in a hydrogen sulfide environment.

Additionally, since, with a 0.2% yield strength of 685 MPa or more, it is possible to make the room-temperature Charpy impact absorption energy 20 J or more and to make the ductility-brittleness transition temperature 80° C. or lower, the turbine rotor material for geothermal power generation will have excellent toughness.

### DESCRIPTION OF EMBODIMENTS

Descriptions will be given hereunder on a turbine rotor material for geothermal power generation and a method for producing the turbine rotor material for geothermal power generation according to one embodiment of the present invention. A low-alloy steel to be used for the turbine rotor material for geothermal power generation according to this embodiment contains C: 0.20 to 0.30 mass %, Si: 0.01 to 0.2 mass %, Mn: 0.5 to 1.5 mass %, Cr: 2.0 to 3.5 mass %, V: more than 0.15 mass % and 0.35 mass % or less, predetermined amounts of Ni and Mo, and a remainder consisting of Fe and inevitable impurities, the Ni made to be more than 0 and 0.25 mass % or less, the Mo made to be 1.05 to 1.50 mass %. A steel ingot having these constituents is melted and refined by an electric furnace or other melting furnace. The melting and refining method for the steel ingot is not specifically limited. The obtained steel ingot (low-alloy steel) is subjected to hot working such as forging. After the hot working, the hot-worked material is subjected to normalizing treatment in an attempt for a homogenous microstructure. Normalizing can be performed by heating a hot-worked material at a furnace temperature of, for example, 1000° C. to 1100° C., and subsequently cooling the hot-worked material in a furnace.

After this, the material is quenched and tempered. Quenching can be performed, for example, by heating the material to 900 to 950° C., and spray quenching the material (from 800° C. down to 500° C. at a cooling rate of 1.0° C./minute or faster). After the quenching, the material can be tempered in which, for example, the material is heated up to 610 to 690° C., and then the material is cooled down. As the duration of tempering, appropriate time length is set depending on a size, shape and the like of a material.

A low-alloy steel produced in a manner described above can be provided with a body (having a diameter of 1600 mm or more) having a room-temperature 0.2% yield strength of 685 MPa or more, room-temperature Charpy impact absorption energy of 20 J or more, and ductility-brittleness transition temperature of 80° C. or lower by means of the above heat treatment. Here, there is no ferrite in a matrix structure of the low-alloy steel and the low-alloy steel has a bainitic homogenous microstructure.

### Experimental Example

Next, descriptions will be given on experimental examples of the present invention. A test steel ingot of 50 kg was melted and refined in a vacuum induction melting furnace, hot-forged at 1000° C. or higher to produce a forging material on the assumption of a turbine rotor material for geothermal power generation, and the forging material was quenched and tempered. With regard to the quenching treatment, after heating the material up to 920° C., on the assumption of a body diameter of 1900 mm, the material was cooled down from 800° C. down to 500° C. at a cooling rate of 1.0° C./minute. With regard to the tempering treatment, the temperature was set in the range from 610 to 690° C. Tension test, impact test, and microstructure observation were performed on samples obtained from the above processes, and a 0.2% yield strength, room-temperature Charpy impact absorption energy, ductility-brittleness transition temperature, and existence of ferrite precipitation were evaluated. Table 2 shows results of the evaluation. Sample numbers, 1 to 5, show experimental examples of a steel of the present invention, and sample numbers, 6 to 18, show experimental examples of a steel for comparison.

TABLE 2

| | | | | | | | | | | Mechanical Property | | |
|---|---|---|---|---|---|---|---|---|---|---|---|---|
| | | | | | | | | | | | Room-temp. | Ductility- |
| | | | | | | | | | Hardenability | | Charpy | brittleness |
| Classifi- | | | | | | | | | Existence | 0.2% yield | impact absorp- | transition |
| cation | Sample | Chemical Composition (mass %) | | | | | | | of ferrite | strength | tion energy | temp. |
| Column | No. | C | Si | Mn | Ni | Cr | Mo | V | precipitation | (MPa) | (J) | (° C.) |
| Steel of | 1 | 0.24 | 0.01 | 0.79 | 0.20 | 2.12 | 1.07 | 0.27 | N | 705 | 85 | 45 |
| Invention | 2 | 0.25 | 0.05 | 0.72 | 0.10 | 2.35 | 1.21 | 0.23 | N | 710 | 92 | 40 |
| | 3 | 0.27 | 0.11 | 1.25 | 0.15 | 2.58 | 1.50 | 0.16 | N | 690 | 62 | 40 |
| | 4 | 0.22 | 0.18 | 0.62 | 0.24 | 2.90 | 1.08 | 0.32 | N | 698 | 95 | 30 |
| | 5 | 0.25 | 0.02 | 0.82 | 0.09 | 3.01 | 1.11 | 0.29 | N | 695 | 80 | 35 |
| Steel for | 6 | 0.27 | 0.03 | 0.20 | 0.83 | 2.19 | 0.81 | 0.18 | N | 649 | 91 | 30 |
| Comparison | 7 | 0.25 | 0.04 | 0.78 | 0.82 | 2.25 | 1.14 | 0.27 | N | 730 | 82 | 50 |
| | 8 | 0.16 | 0.22 | 1.23 | 0.37 | 2.05 | 1.25 | 0.16 | N | 675 | 40 | 60 |
| | 9 | 0.20 | 0.21 | 0.74 | 0.42 | 2.83 | 1.13 | 0.37 | N | 742 | 14 | 85 |
| | 10 | 0.28 | 0.03 | 0.76 | 0.10 | 2.11 | 1.97 | 0.25 | N | 719 | 17 | 105 |
| | 11 | 0.25 | 0.04 | 0.08 | 0.10 | 2.25 | 1.14 | 0.23 | Y | 628 | 15 | 90 |
| | 12 | 0.25 | 0.03 | 0.77 | 0.10 | 2.98 | 1.96 | 0.28 | N | 732 | 16 | 85 |
| | 13 | 0.28 | 0.24 | 0.84 | 0.46 | 1.19 | 1.29 | 0.21 | Y | 672 | 12 | 95 |
| | 14 | 0.14 | 0.27 | 0.73 | 0.43 | 2.03 | 1.15 | 0.23 | N | 520 | 87 | 20 |
| | 15 | 0.25 | 0.28 | 0.74 | 0.39 | 1.95 | 1.67 | 0.23 | N | 780 | 18 | 95 |
| | 16 | 0.23 | 0.05 | 0.06 | 1.27 | 2.42 | 1.20 | 0.18 | N | 661 | 65 | 5 |
| | 17 | 0.26 | 0.04 | 0.47 | 0.51 | 2.11 | 1.09 | 0.17 | N | 628 | 160 | 10 |
| | 18 | 0.24 | 0.04 | 0.10 | 0.49 | 2.19 | 1.07 | 0.15 | N | 628 | 135 | 30 |

No precipitation of ferrite was found in the steel according to the experimental examples of the present invention (No. 1 to 5), and the steel sufficiently satisfied the targeted 0.2% yield strength, room-temperature Charpy impact absorption energy, and ductility-brittleness transition temperature. On the other hand, in the case of the steel according to comparative examples (No. 6, 8 to 10, 12, and 14 to 18), even though there was no precipitation of ferrite, and hardenability was secured, the steel could not satisfy one or two among the targeted 0.2% yield strength, room-temperature Charpy impact absorption energy, and ductility-brittleness transition temperature. Additionally, in the steel according to the comparative examples (No. 11 and 13), ferrite has precipitated, which decreased the 0.2% yield strength and room-temperature Charpy impact absorption energy and enhanced the ductility-brittleness transition temperature. That is to say, the steel of the present invention substantiates a targeted steel quality having no precipitation of ferrite and excellent in both strength and toughness.

Next, based on a test method of NACE (National Association of Corrosion Engineers) standard TM0177-Method B, SCC resistance was evaluated by 3-point bend test in a saturated H2S solution to which acetic acid of 0.5 mass % was added. In the test, test specimens of 67.3×4.57×1.52 mm were used, stress was loaded in the range from 0.33 G to 0.70 G, the test specimens were soaked in the saturated H2S solution for 720 hours, and existence of ruptures was evaluated. Table 3 shows results of the test conducted on the test specimens of the steel of the present invention (No. 1) and of the steel according to the comparative examples (No. 7 and 13). Here, the symbol, G, indicates 0.2% yield strength of the samples. In the table, N indicates no rupture, and Y indicates the existence of rupture(s).

TABLE 3

| | Sample No. | |
|---|---|---|
| Load | Steel of | Steel for |
| Stress | Invention | Comparison |

| (MPa) | 1 | 7 | 13 |
|---|---|---|---|
| 0.70 σ | Y | Y | Y |
| 0.67 σ | Y | Y | Y |
| 0.63 σ | Y | Y | Y |
| 0.60 σ | Y | Y | Y |
| 0.56 σ | N | Y | N |
| 0.53 σ | N | Y | N |
| 0.50 σ | N | N | N |
| 0.47 σ | N | N | N |
| 0.45 σ | N | N | N |
| 0.42 σ | N | N | N |
| 0.40 σ | N | N | N |
| 0.37 σ | N | N | N |
| 0.33 σ | N | N | N |

The steel according to the experimental example of the present invention (No. 1) showed better SCC resistance than that of the steel according to one of the comparative examples (No.7). On the other hand, the steel according to the other one of the comparative examples (No. 13) showed SCC resistance equivalent to that of the steel according to the experimental example of the present invention, however, did not satisfy the targeted strength and toughness. That is to say, the steel according to the experimental example of the present invention satisfies all necessary properties, substantiating the suitability as a material for a large turbine rotor for geothermal power generation.

Next, experimental examples by which influences of quenching and tempering conditions on strength and toughness have been studied will be stated. A 50 kg test steel ingot having the constituents of the sample No. 1 was melted and refined in a vacuum induction melting furnace, hot-forged at 1000° C. or higher to produce a forging material on the assumption of a turbine rotor material for geothermal power generation, and the forging material was subjected to quenching and tempering treatment shown in Table 4. With regard to a cooling rate in the quenching, on the assumption of a body diameter of 1900 mm, the forging material was cooled from 800° C. down to 500° C. at a cooling rate of 1.0° C./minute. Tension test, impact test, microstructure observation, and grain size measurement were performed on a sample obtained from the above processes, and 0.2% yield strength, room-temperature Charpy impact absorption energy, ductility-brittleness transition temperature, existence of ferrite precipitation, and crystal grain size were evaluated.

TABLE 4

| | | | Mechanical Property | | | |
|---|---|---|---|---|---|---|
| | | | | Room-temp. | Ductility- | |
| Quenching | Tempering | Hardenability | | Charpy | brittleness | |
| Temper- | Temper- | Existence | 0.2% yield | impact absorp- | transition | Grain |
| ature | ature | of ferrite | strength | tion energy | temp. | Size |
| (° C.) | (° C.) | precipitation | (MPa) | (J) | (° C.) | Number |
| 920 | 600 | N | 917 | 15 | 150 | 4.5 |
| | 635 | N | 765 | 32 | 70 | |
| | 660 | N | 713 | 83 | 40 | |
| | 700 | N | 552 | 192 | −25 | |
| 950 | 600 | N | 919 | 10 | 135 | 4.0 |
| | 635 | N | 776 | 46 | 65 | |
| | 660 | N | 721 | 87 | 45 | |
| | 700 | N | 567 | 185 | −10 | |
| 1000 | 600 | N | 932 | 6 | 160 | 2.6 |
| | 635 | N | 783 | 28 | 85 | |
| | 660 | N | 735 | 48 | 80 | |
| | 700 | N | 577 | 89 | 20 | |

As shown in Table 4, when the quenching temperature rises up to 1000° C., as compared with the temperatures of 920° C. and 950° C., the grain size coarsened, declining the room-temperature Charpy impact absorption energy and enhancing the ductility-brittleness transition temperature. Also, the tempering temperature of 600° C. could not satisfy the targeted room-temperature Charpy impact absorption energy and ductility-brittleness transition temperature, and the tempering temperature of 700° C. could not satisfy the targeted 0.2% yield strength. On the other hand, the samples on which quenching at the temperatures of 920° C. and 950° C. and tempering at the temperatures of 635° C. and 660° C. were performed satisfied all targets for the 0.2% yield strength, room-temperature Charpy impact absorption energy, and ductility-brittleness transition temperature, being superior to the samples having been quenched and tempered on different heat-treatment conditions. That is to say, it has been substantiated that excellent strength and toughness can be obtained by selecting an appropriate heat-treatment condition.

The present invention is not limited to the scope described in the above embodiments and experimental examples, and can also be applied to a turbine rotor material for geothermal power generation and a method for producing the turbine rotor material for geothermal power generation which do not alter the gist of the present invention.

### INDUSTRIAL APPLICABILITY

The turbine rotor material for geothermal power generation and the method for producing the turbine rotor material for geothermal power generation according to the present invention enable the quenching of a body having a diameter of 1600 mm or more, being suitable as a rotor to be used in a large geothermal plant. Also, since sufficient resistance to stress corrosion cracking is provided, the turbine rotor material for geothermal power generation and the method for producing the turbine rotor material for geothermal power generation according to the present invention are usable not only just for geothermal power generation, but also as other rotors of similar environments.

1-4. (canceled)

5. A turbine rotor material for geothermal power generation, comprising:
C: 0.20 to 0.30 mass %;
Si: 0.01 to 0.2 mass %;
Mn: 0.5 to 1.5 mass %;
Cr: 2.0 to 3.5 mass %;
V: more than 0.15 mass % and 0.35 mass % or less;
predetermined amounts of Ni and Mo; and
a remainder consisting of Fe and inevitable impurities, the Ni made to be more than 0 and
0.25 mass % or less, the Mo made to be 1.05 to 1.5 mass %.

6. The turbine rotor material for geothermal power generation according to claim 5,
wherein there is no ferrite in a matrix structure and the matrix structure is a bainitic homogeneous microstructure.

7. The turbine rotor material for geothermal power generation according to claim 5,
wherein the turbine rotor material for geothermal power generation is provided with a body having a diameter of at least 1600 mm, room-temperature 0.2% yield strength of 685 MPa or more, room-temperature Charpy impact absorption energy of 20 J or more, and ductility-brittleness transition temperature of 80° C. or lower.

8. The turbine rotor material for geothermal power generation according to claim 6, wherein the turbine rotor material for geothermal power generation is provided with a body having a diameter of at least 1600 mm, room-temperature 0.2% yield strength of 685 MPa or more, room-temperature Charpy impact absorption energy of 20 J or more, and ductility-brittleness transition temperature of 80° C. or lower.

9. A method for producing a turbine rotor material for geothermal power generation, comprising:
hot-forging a steel ingot having constituents of the turbine rotor material for geothermal power generation of claim 5;
performing quenching treatment that heats the forged material to 900 to 950° C. and cools down the forged material from 800° C. down to 500° C. at a cooling rate of 1.0° C./minute or faster; and
performing tempering treatment that re-heats the forged material to retain a temperature of 610 to 690° C. and subsequently cools down the forged material.

10. A method for producing a turbine rotor material for geothermal power generation, comprising:
hot-forging a steel ingot having constituents of the turbine rotor material for geothermal power generation of claim 6;
performing quenching treatment that heats the forged material to 900 to 950° C. and cools down the forged material from 800° C. down to 500° C. at a cooling rate of 1.0° C./minute or faster; and
performing tempering treatment that re-heats the forged material to retain a temperature of 610 to 690° C. and subsequently cools down the forged material.

11. A method for producing a turbine rotor material for geothermal power generation, comprising:
hot-forging a steel ingot having constituents of the turbine rotor material for geothermal power generation of claim 7;
performing quenching treatment that heats the forged material to 900 to 950° C. and cools down the forged material from 800° C. down to 500° C. at a cooling rate of 1.0° C./minute or faster; and
performing tempering treatment that re-heats the forged material to retain a temperature of 610 to 690° C. and subsequently cools down the forged material.
